(19) United States
(12) Patent Application Publication
(10) Pub. No.: US 2007/0158538 A1
(43) Pub. Date: Jul. 12, 2007

(54) Image Sensor Module and Method for Manufacturing the Same

(75) Inventor: Sheng-Yuan Wang, Kaohsiung (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ADVANCED SEMICONDUCTOR ENGINEERING INC., Kaohsiung (TW)

(21) Appl. No.: 11/553,545

(22) Filed: Oct. 27, 2006

(30) Foreign Application Priority Data
Jan. 11, 2006 (TW) 95101086

(51) Int. Cl. H01J 5/02; H01J 40/14

(52) U.S. Cl. 250/239

(57) ABSTRACT

An image sensor module includes a substrate having a central protrusion formed on an upper surface thereof, an optical sensor chip disposed on the central protrusion and electrically coupled to the substrate, and a lens module disposed on the upper surface of substrate at a location outside the central protrusion. The lens module has a cavity for receiving the optical sensor chip. The central protrusion of the substrate fits to the opening of the cavity of the lens module.

### RELATED APPLICATIONS

The present application is based on, and claims priority from, Taiwan Application Serial Number 95101086, filed Jan. 11, 2006, the disclosure of which is hereby incorporated by reference herein in its entirety.

### FIELD OF THE INVENTION

This invention relates generally to an image sensor module and a method for manufacturing the same, and more particularly, to an image sensor module having functions of reducing light leakage and alignment deviation and a method for manufacturing the same.

### BACKGROUND OF THE INVENTION

Reference is made to FIG. 1, which depicts a cross-sectional diagram of the structure of the prior image sensor module, which mainly includes a substrate 10, an optical sensor chip (i.e. CMOS chip) 20, and a lens module 30. The substrate 10 is a printed circuit board (PCB), which has an upper surface 12 and a lower surface 14 opposite to the upper surface 12, wherein the upper surface 12 has a plurality of circuit contacts 16 disposed thereon. The optical sensor chip 20 is disposed on the upper surface 12 of the substrate 10, and it is electrically connected to the circuit contacts 16 on the substrate 10 by way of a plurality of conductive wires 22. The lens module 30, which comprises a barrel 32, a holder 34, a lens 36, an infrared filter 38 and a cavity 55, is disposed on the upper surface 12 of the substrate 10. The optical sensor chip 20 and the lens module 30 are respectively adhered and fixed to the substrate 10, using an adhesive material 50. The cavity 55 of the lens module 30 entirely covers and protects the optical sensor chip 20 from contamination of outside particles and interference of light leakage.

However, as the lens module 30 of the above image sensor module is installed on the substrate 10, it needs to insert a positioning bolt 34a of the holder 34 to a corresponding positioning hole 10a of the substrate 10 for attaching it to a desired position. And then, the holder 34 is adhered and fixed on the substrate 10 by using the adhesive material 50. Due to the process requirement, the positioning hole 10a is larger than the positioning bolt 34a in size. After the image sensor module is assembled completely, the light easily penetrates into the lens module 30 from the positioning hole 10a on the lower surface 14 of the substrate 10, resulting in the issue of aggravating image sensor quality. At this time, if an opaque adhesive material is employed to seal the positioning hole 10a on the lower surface 14 of the substrate 10 completely, it will need to add an additional treatment, and cause the increase of time and cost of package process.

### SUMMARY OF THE INVENTION

Accordingly, there is an urgent need to provide an improved package structure of the image sensor module and a method for manufacturing the same, so as to solve the light leakage problem of the image sensor module, thereby achieving the purpose of increased image sensor quality and the process yield.

An aspect of the present invention provides a package structure of the image sensor module, which has a substrate designed to have a central protrusion that directly fits to a holder of the lens module for positioning, so as to solve the light leakage problem of the image sensor module.

Another aspect of the present invention provides a method for manufacturing an image sensor module, which detects a center of a sensing region of an optical sensor chip, and then aligns the lens optical axis to the center, so that the lens optical axis of the lens module is substantially situated at the center of the sensing region, thereby greatly increasing the image sensor quality and the process yield.

According to the aforementioned aspect of the present invention, the package structure of the image sensor module of a preferred embodiment comprises a substrate having an upper surface and a lower surface opposite to the upper surface, wherein a central protrusion is formed on the upper surface, and the central protrusion has a plurality of circuit contacts disposed thereon; an optical sensor chip disposed on the central protrusion, wherein the optical sensor chip is electrically connected to the circuit contacts; and a lens module disposed at a location outside the central protrusion on the upper surface, wherein the lens module has a cavity for receiving the optical sensor chip, and the central protrusion of the substrate fits to an opening of the cavity of the lens module.

According to another aspect of the present invention, the method for manufacturing the image sensor module of another preferred embodiment of the present invention comprises steps as follows. A substrate is provided, which has an upper surface and a lower surface opposite to the upper surface, wherein a central protrusion is formed on the upper surface, and the central protrusion has a plurality of circuit contacts disposed thereon; an optical sensor chip is disposed on the central protrusion; the optical sensor chip is electrically connected to the circuit contacts; and a lens module is disposed at a location outside the central protrusion on the upper surface, wherein the lens module has a cavity for receiving the optical sensor chip, and the central protrusion of the substrate fits to an opening of the cavity of the lens module.

In another preferred embodiment of the present invention, the aforementioned substrate may be, for example, a PCB.

In another preferred embodiment of the present invention, the aforementioned optical sensor chip may be, for example, a photodiode.

In another preferred embodiment of the present invention, the aforementioned optical sensor chip may be, for example, a charge-coupled device (CCD).

In another preferred embodiment of the present invention, the aforementioned optical sensor chip may be, for example, a phototransistor complementary metal-oxide semiconductor (CMOS) sensor device.

With application to the aforementioned package structure of the image sensor module, the substrate is designed to have the central protrusion formed thereon, so that the central protrusion directly fits to the holder of the lens module for positioning, so as to solve the light leakage problem of the image sensor module. In addition, when the package structure of the image sensor module of the present invention is packaging, an aligning process is carried out between a lens optical axis of the lens module and a center of an optical sensor area of the optical sensor chip, so as to ensure the lens optical axis of the lens module being substantially aligned to the center of an optical sensor area of the optical sensor chip, thereby greatly increasing the image sensor quality and the process yield. Hence, in comparison with other prior package structures and packaging processes, the structure and the method disclosed by the present invention are capable of solving the problem of low image sensor quality, and greatly reducing the process time and cost as well.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a cross-sectional diagram of the structure of the prior image sensor module;

FIG. 2 is a cross-sectional diagram of a package structure of an image sensor module according to one preferred embodiment of the present invention; and

FIG. 3 is a flowchart of the method for manufacturing the image sensor module according to another preferred embodiment of the present invention.

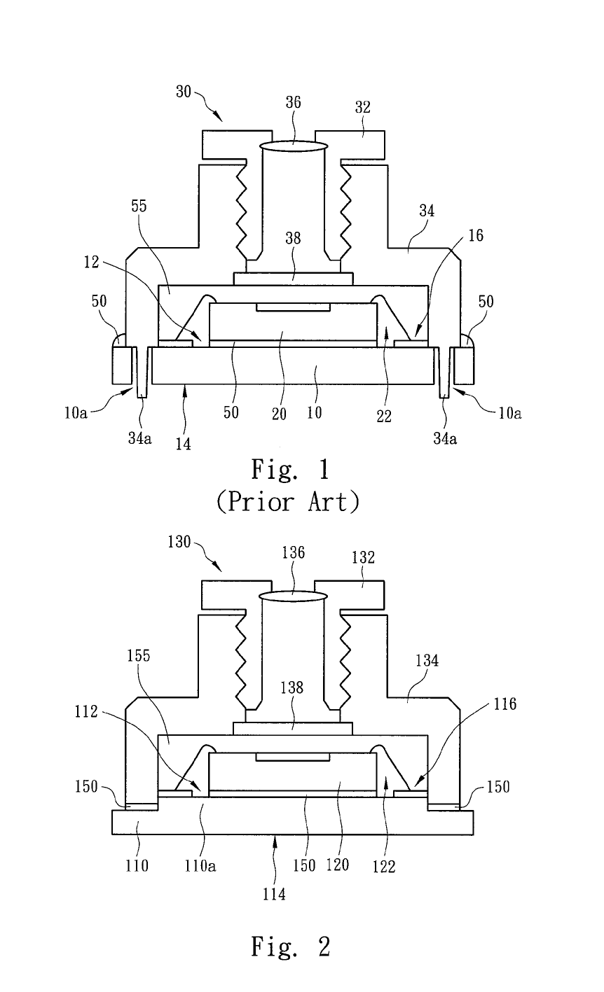

### DETAILED DESCRIPTION OF THE PREFERRED EMBODIMENT

Reference is made to FIG. 2, which depicts a cross-sectional diagram of a package structure of an image sensor module according to one preferred embodiment of the present invention. The package structure of the image sensor module comprises a substrate 110 having a central protrusion 110a, an optical sensor chip 120 and a lens module 130. In this embodiment, the substrate 110 may be a PCB, which has an upper surface 112 and a lower surface 114 opposite to the upper surface 112, wherein the central protrusion 110a is formed on the upper surface 112, and the central protrusion 110a has a plurality of circuit contacts 116 disposed thereon.

The optical sensor chip 120, for example, a photodiode, a CCD or a phototransistor CMOS sensor device, is disposed on the central protrusion 110a of the substrate 110, wherein the optical sensor chip 120 is electrically connected to the circuit contacts 116 on the central protrusion 110a by way of a plurality of conductive wires 122.

The lens module 130, which comprises a barrel 132, a holder 134, a lens 136 and an infrared filter 138, is disposed at a location outside the central protrusion 110a on the upper surface 112 of the substrate 110. In this embodiment, the optical sensor chip 120 and the lens module 130 are adhered and fixed to the central protrusion 110a and the location outside the central protrusion 110a of the substrate 110, respectively, using an adhesive material 150. The cavity 155 of the holder 134 entirely contains, covers and protects the optical sensor chip 120 from contamination of outside particles and interference of light leakage. The present invention is characterized by, during the lens module 130 is installed on the substrate 110, fitting the central protrusion 110a of the substrate 110 to the opening (not shown) of the cavity 155 of the holder 134 for attaching the holder 134 to a desired position, and adhering and fixing the holder 134 to the substrate 110 by using the adhesive 150. Therefore, differing from the prior positioning method that needs to insert a positioning bolt to a corresponding positioning hole, the positioning method of the preset invention prevents using the positioning hole applied in the prior positioning method, so that the problem related to the positioning hole, such as aggravating image quality, is successfully solved. Besides, the central protrusion 110a of the substrate 110 of the present invention not only serves to attach the holder 134 to the desired position, but also has the function of blocking light leakage from the junction between the holder 134 and the substratel 10. Thus, as the process of curing the adhesive material 150 causes the substrate 110 to be distorted unexpectedly, the central protrusion 110a of the substrate 110 of the present invention can be applied to block light leakage from the junction between the holder 134 and the substrate 110, so as to solve the aforementioned light leakage problem. It is worth mentioning that, in accordance with the process demand, the central protrusion 110a is substantially and slightly smaller than the opening of the cavity 115 in size. In addition, in this embodiment, the adhesive material 150 is an opaque adhesive for preventing light from penetrating into the lens module 130.

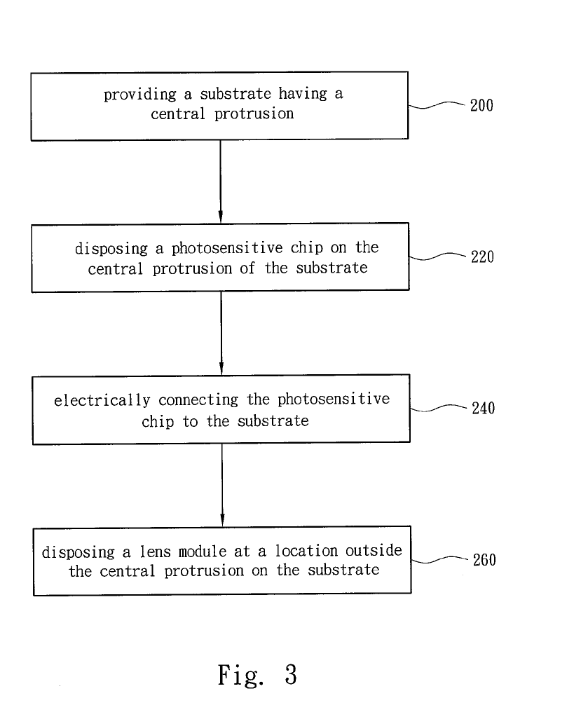

Reference is made to FIG. 3, which depicts a flowchart of the method for manufacturing the image sensor module according to another preferred embodiment of the present invention. The method for manufacturing the image sensor module comprises steps as follows. At first, a substrate having a central protrusion is provided, as described in the step 200 of FIG. 3. In this embodiment, the substrate is a PCB, which has an upper surface and a lower surface opposite to the upper surface, wherein a central protrusion is formed on the upper surface, and the central protrusion has a plurality of circuit contacts disposed thereon.

Next, an optical sensor chip is disposed on the central protrusion of the substrate, as described in the step 220 of FIG. 3. In this embodiment, the adhesive material serves to adhere the optical sensor chip to the central protrusion, and the adhesive material is cured during the curing process.

Afterward, the optical sensor chip is wired to electrically connect with the circuit contacts on the central protrusion of the substrate, as described in the step 240 of FIG. 3.

Later, a lens module is disposed at a location outside the central protrusion on the upper surface of the substrate, as described in the step 260 of FIG. 3, so as to complete the package structure of the image sensor module, wherein the lens module comprises a barrel, a holder and a lens. In this embodiment, the lens module is installed on the substrate in a manner of attaching it to a desired position, that is to say, the central protrusion of the substrate fits to an opening of the cavity of the lens module, and the adhesive material serves to adhere and fix the holder at a location outside the central protrusion of the substrate. Moreover, in order to avoid the influence of the process tolerance, for example, the size difference between the opening of the cavity of the holder and the central protrusion of the substrate, or the position deviation occurred in adhering and fixing the optical sensor chip to the central protrusion, resulting in the decentering issue during assembling the module, the present invention is further characterized by employing the adhesive material to attach the holder to a location outside the central protrusion on the upper surface of the substrate. Before the adhesive material is cured, an aligning process is carried out, for enabling the lens optical axis to align the center of the sensing region of the optical sensor chip. The adhesive material is cured after finishing the aligning process, thereby completing the package process of the image sensor module.

The above aligning process comprises following steps of: detecting any three angles on an edge of the optical sensor chip; and aligning the lens optical axis to the center. It is worth mentioning that, the adhesive material may be previously coated on the holder or the substrate, and the pre-coated adhesive material is directly employed to temporarily fix the holder and the substrate while the central protrusion of the substrate is fixing to the opening of the cavity of the holder. And then, the aligning process is carried out. Afterward, the holder and the substrate, which have been subjected to the aligning process, are directly subjected to a curing step, so as to permanently fix the holder and the substrate. In this embodiment, since the above aligning process is to align the lens optical axis to the center, the decentering issue during assembling the module, which is caused by the process tolerance occurring in adhering and fixing the optical sensor chip, as well as the manufacturing tolerance occurring in the holder of the lens module itself, can be considerably decreased.

In brief, the package structure of the image sensor module of the present invention is characterized by the design of the substrate having the central protrusion formed thereon, so that the central protrusion directly fits to the opening of the cavity of the lens module for attaching it to a desired position while the lens module is installed on the substrate. Therefore, the positioning method of the present invention is not necessary to inserts any positioning bolt to a corresponding positioning hole, and the substrate structure of the present invention has no positioning hole, so that the problem due to light leakage resulting from the positioning hole does not occurs. Besides, the central protrusion of the substrate of the present invention also takes another advantage, that is to say, it can serve to prevent light penetrating from the junction between the holder and the substrate while light leakage occurs herein. In comparison with the prior structure, the structure of the present invention can substantially prevent light through the gap of the package structure into the lens module, thereby greatly increasing the image sensor quality and the process yield.

Therefore, according to the aforementioned preferred embodiments, one advantage of the method for manufacturing the image sensor module of the present invention is that, the central protrusion of the substrate directly fits to the opening of the cavity of the lens module, so as to achieve the purpose of attaching it to a desired position. As well, in order to prevent the influence of the process tolerance, the present invention adds an aligning process for enabling the lens optical axis of the lens module to align the center of the sensing region of the optical sensor chip, so as to avoid the decentering issue during assembling the module. Therefore, the method for manufacturing the image sensor module of the present invention not only solves the decentering issue of the prior structure occurring in the packaging process, but also greatly increases the image sensor quality and the process yield, thereby reducing the process time and cost.

As is understood by a person skilled in the art, the foregoing preferred embodiments of the present invention are illustrated of the present invention rather than limiting of the present invention. It is intended to cover various modifications and similar arrangements included within the spirit and scope of the appended claims. Therefore, the scope of which should be accorded the broadest interpretation so as to encompass all such modifications and similar structure.

What is claimed is:

1. An image sensor module, comprising:
a substrate having an upper surface and a lower surface opposite to the upper surface, wherein a central protrusion is formed on the upper surface, and the central protrusion has a plurality of circuit contacts disposed thereon;
an optical sensor chip disposed on the central protrusion, wherein the optical sensor chip is electrically connected to the circuit contacts; and
a lens module disposed at a location outside the central protrusion on the upper surface, wherein the lens module has a cavity for receiving the optical sensor chip, and the central protrusion of the substrate fits to an opening of the cavity of the lens module.

2. The image sensor module according to claim 1, further comprising an adhesive material for fixing the lens module on the substrate.

3. The image sensor module according to claim 2, wherein the adhesive material is an opaque adhesive.

4. The image sensor module according to claim 1, wherein the substrate is a printed circuit board (PCB).

5. The image sensor module according to claim 1, wherein the optical sensor chip is a charge-coupled device (CCD).

6. The image sensor module according to claim 1, wherein the optical sensor chip is a phototransistor complementary metal oxide semiconductor (CMOS) sensor device.

7. The image sensor module according to claim 1, wherein the optical sensor chip is a photodiode.

8. A method for manufacturing an image sensor module, comprising:
providing a substrate having an upper surface and a lower surface opposite to the upper surface, wherein a central protrusion is formed on the upper surface, and the central protrusion has a plurality of circuit contacts disposed thereon;
disposing an optical sensor chip on the central protrusion;
electrically connecting the optical sensor chip to the circuit contacts; and
disposing a lens module at a location outside the central protrusion on the upper surface, wherein the lens module has a cavity for receiving the optical sensor chip, and the central protrusion of the substrate fits to an opening of the cavity of the lens module.

9. The method for manufacturing the image sensor module according to claim 8, wherein the step of disposing the lens module further comprises:
applying an adhesive material so as to attach the lens module to the location;
carrying out an aligning process, so that a lens optical axis of the lens module is aligned to a center of an optical sensor area of the optical sensor chip; and
curing the adhesive material after the aligning process.

10. The method for manufacturing the image sensor module according to claim 9, wherein the aligning process comprises:
detecting any three angles on an edge of the optical sensor chip, so as to obtain the center of the optical sensor area; and
aligning the lens optical axis to the center.

11. The method for manufacturing the image sensor module according to claim 9, wherein the adhesive material is an opaque adhesive.

12. The method for manufacturing the image sensor module according to claim 8, wherein the substrate is a PCB.

13. The method for manufacturing the image sensor module according to claim 8, wherein the optical sensor chip is a CCD.

14. The method for manufacturing the image sensor module according to claim 8, wherein the optical sensor chip is a phototransistor CMOS sensor device.

15. The method for manufacturing the image sensor module according to claim 8, wherein the optical sensor chip is a photodiode.
